(19) United States
(12) Patent Application Publication
(10) Pub. No.: US 2019/0317756 A1
(43) Pub. Date: Oct. 17, 2019

(54) SOFTWARE ARTIFACT MANAGEMENT SYSTEMS AND METHODS

(71) Applicant: Walmart Apollo, LLC, Bentonville, AR (US)

(72) Inventors: Rick J Bough, Bentonville, AR (US); Trey Vanderpool, Bentonville, AR (US); Richard Ulrich, Bentonville, AR (US); Oscar Blass, Bentonville, AR (US); Ron Longenecker, Centerton, AR (US)

(21) Appl. No.: 16/380,371

(22) Filed: Apr. 10, 2019

Related U.S. Application Data
(60) Provisional application No. 62/656,029, filed on Apr. 11, 2018.

(51) Int. Cl. G06F 8/71

(52) U.S. Cl. CPC G06F 8/71

(57) ABSTRACT

A package management system for binary files that include executable instructions (such as executable files, statically linked libraries, and dynamically linked libraries). The system comprises a packager configured to identify a plurality of build artifacts used to create an original binary file, and create and store an augmented binary file comprising the plurality of build artifacts appended to the original binary file, such that the augmented binary file has the same functionality when executed as the original binary file. The system can further include an extractor configured to receive the augmented binary file and produce an output comprising the plurality of build artifacts from the augmented binary file.

### RELATED APPLICATION

The present application claims the benefit of U.S. Provisional Application No. 62/656,029 filed Apr. 11, 2018, which is hereby incorporated herein in its entirety by reference.

### TECHNICAL FIELD

Embodiments of the present disclosure relate generally to the field of software development systems, and more particularly to systems and methods for managing software artifacts.

### BACKGROUND

Executable files, such as .EXE files, are binary files that often built from a variety of artifacts including source code, statically linked libraries, configuration files, and the like. Many build artifacts used to create an executable code are themselves built from a variety of artifacts, either prior to or during the build process for the primary executable.

Build scripts such as makefiles can be run to automatically retrieve the build artifacts and other sub-components necessary to create an executable file, launch the necessary build tools such as compilers and linkers, and produce output including the built executable file and reports of the build status. When the build environment for a given executable file is known and available, the file can be recreated at will.

Complex operational environments can include hundreds or thousands of systems, each having its own local configuration and set of binary files. While configuration management tools and techniques aim to track and reduce the complexity of maintaining software across multiple systems, software versions can drift over time. This can cause issues when software maintenance or enhancement is needed. Often, individual systems may have different versions of an executable or other binary file due of hardware differences, user requirements, business capabilities, or the like. In order to assess (and mitigate) the impact of any software changes, administrators need to be able to trace from an executable file and the build artifacts used to create it.

Some executable file formats (such as the Portable Executable format) enable metadata that describes or links to the original build artifacts to be added to an executable file. This metadata is limited to file names, version numbers, and details of how to connect to a build artifact repository (such as a version control system). If the original build artifacts are no longer available (for example, if the build artifact repository has been taken offline, or the metadata was incorrectly specified when built), it can be impossible to determine the provenance of any particular executable, or to make changes to accommodate other system needs.

As an example, when executable programs are migrated to new servers, years or even decades may have passed since the executable program was first deployed. When moving this code the original source code is difficult to find. Even when no migration is occurring, effective troubleshooting can often require looking within the “black box” of an executable program to see what it is doing and why.

The results of this environmental drift include a number of increased costs. Legacy systems and repositories may need maintaining in order to support applications that cannot be easily ported or migrated. Security infrastructure may be needed to protect against security issues or bugs that cannot be fixed in the underlying software. In addition, the ability of administrators to troubleshoot or debug issues can be limited where source code for applications is no longer available.

### SUMMARY

Embodiments of the present disclosure provide a package management system for creating and interpreting an augmented binary file that includes metadata, source code, and other build artifacts used to create an original binary file.

Embodiments of the present disclosure include a package management system for binary files that include executable instructions (such as executable files, statically linked libraries, and dynamically linked libraries). In embodiments, the system comprises a packager configured to identify a plurality of build artifacts used to create an original binary file, and create and store an augmented binary file comprising the plurality of build artifacts appended to the original binary file, such that the augmented binary file has the same functionality when executed as the original binary file. The system can further include an extractor configured to receive the augmented binary file and produce an output comprising the plurality of build artifacts from the augmented binary file.

In embodiments, the packager is further configured to retrieve one or more prerequisite build artifacts, each required to create at least one of the plurality of build artifacts, and to add the one or more prerequisite build artifacts to the plurality of build artifacts. The prerequisite build artifacts can be added to the plurality of build artifacts by creating an augmented build artifact comprising a build artifact and the prerequisite build artifacts required to create the build artifact; and adding the augmented build artifact to the plurality of build artifacts.

In embodiments, the packager is further configured to append a bill of materials to the augmented binary file. The bill of materials can comprise data identifying each build artifact of the plurality of build artifacts. In embodiments, the system can further comprise a program information tool configured to receive the augmented binary file and produce an output comprising the bill of materials.

In embodiments, the packager is configured to append the plurality of build artifacts to the original binary file by combining the plurality of build artifacts into an archive file and appending the archive file to the original binary file.

In embodiments, each build artifact of the plurality of build artifacts has a type selected from the group consisting of: source code file, source code directory structure, library file, build parameter, build script, system components, build machine configuration, and build machine image.

In embodiments, the packager is further configured to encrypt the plurality of build artifacts such that the extractor requires a decryption key to produce an output comprising the plurality of build artifacts from the augmented binary file. In embodiments, the packager is further configured to retrieve the plurality of build artifacts from one or more source code repositories.

In embodiments, the extractor is further configured to build a new executable using the plurality of build artifacts of the received augmented binary file.

In embodiments, the packager is further configured to append an identification signature to the augmented binary file. The identification signature can be recognizable by a software auditing tool.

In an embodiment, a method for building a binary file including executable instructions comprises: identifying a plurality of build artifacts used to create an original binary file, creating and storing an augmented binary file comprising the plurality of build artifacts appended to the original binary file, the augmented binary file having the same functionality when executed as the original binary file, extracting the plurality of build artifacts from the augmented binary file; and creating a new binary file with the extracted plurality of build artifacts.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a schematic diagram depicting the architecture of a package management system, according to an embodiment.

FIG. 2A is a schematic diagram depicting the data structure of a bill of materials, according to an embodiment.

FIG. 2B is a schematic diagram depicting the data structure of a build artifact archive, according to an embodiment.

FIG. 3 is a method for creating an augmented binary file, according to an embodiment.

FIG. 4 is a text listing of an example bill of materials output, according to an embodiment.

FIG. 5 is a method for extracting a bill of materials and build artifact archive from a binary file, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

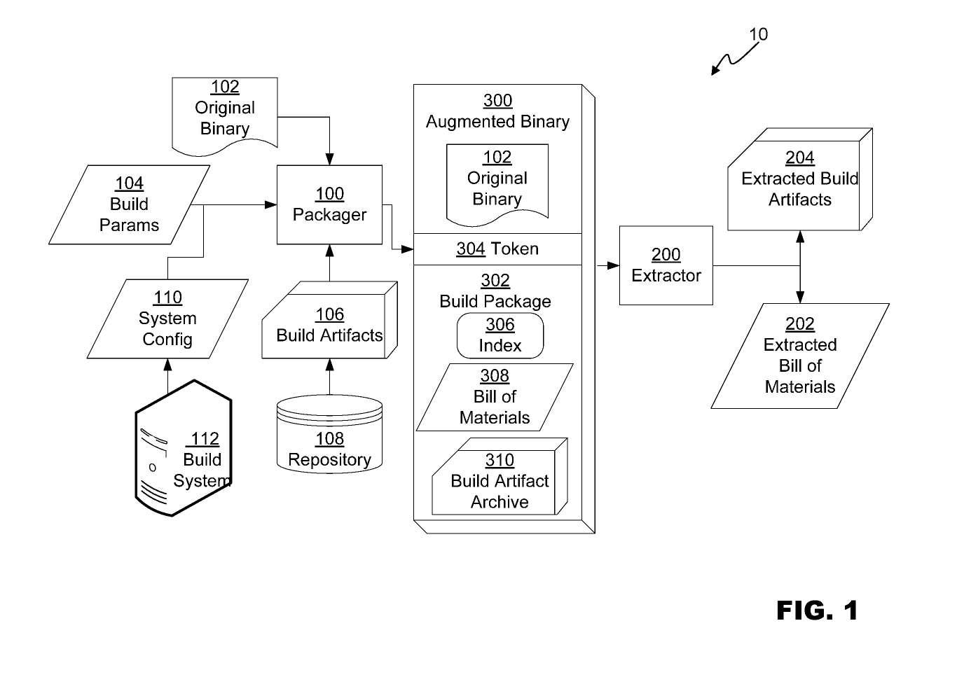

FIG. 1 is a schematic view depicting the architecture of a package management system 10, according to an embodiment. Package management system 10 comprises a packager 100, and extractor 200. Packager 100 produces augmented binary 300. Augmented binary 300 can comprise data that can be viewed or extracted by extractor 200.

Software build processes known in the art generally produce one or more original binaries 102. An original binary 102 can be an executable program, or a subprogram such as a statically or dynamically linkable library. Statically linked libraries are also known as object files, and dynamically linkable libraries are also known as DLLs. Like other files stored in volatile or non-volatile computer memories, original binary 102 can comprise a computer file organized into a one-dimensional array of bytes.

Generally, executable programs and library files have organizational structures enabling an operating system to recognize processing instructions in the file. The operating system can interpret these encoded instructions and perform the indicated tasks. Example binary file formats known in the art include Portable Executable (PE), a.out, Common Object File Format (COFF), Executable and Linkable Format (ELF) or the like. Some operating systems support executable archives that comprise directory structures including frameworks and resource artifacts as well as executable code. Embodiments of the present disclosure can receive original binaries 102 in one or more formats known in the art, and produce augmented binaries 300 in one or more formats known in the art. In an exemplary embodiment, augmented binary 300 can comprise the same format as the provided original binary 102.

Generally, operating systems interpret the binary files sequentially. Data appended to the one-dimensional array after any executable code is ignored. Further, some binary file formats such as PE and ELF explicitly enable the inclusion of metadata. Metadata can include information such as debugging symbols enabling development tools to map between instructions in the binary and source code, or other build artifacts. Therefore, additional information can be added to binary file formats known in the art without affecting the performance of a binary executable or library.

Embodiments of the present disclosure can create and interpret an augmented binary 300 comprising a copy of an original binary 102 and build package 302. Augmented binary 300 can provide equivalent functionality to original binary 102 when interpreted by an operating system. Build package 302 can comprise a subsection of a metadata section of a binary file format, or can be appended to the end of a copy of original binary 102. In embodiments, build package 302 can be preceded by a token 304, which can be a magic cookie, a particular hexadecimal code (such as 0x65653de34d), or other particular data sequence inserted between the end of original binary 102 and the beginning of build package 302. Build package 302 can comprise an index 306 indicating the data locations of various portions of a bill of materials 308 and a build artifact archive 310.

Packager 100 can receive original binary 102, build parameters 104, and system configuration 110. Build parameters 104 can comprise compiler flags, linker flags, command line parameters, environmental variables, or any other configuration flags, settings, or parameters passed to and/or used by build tools such as compilers, linkers, and the like to create original binary 102. Build parameters 104 can further comprise an identification of the build artifacts 106 used to create original binary 102. Build parameters 104 can further comprise the location of a repository (or repositories 108) where build artifacts 106 are stored. Each repository 108 can comprise any source or artifact repository or version control system that enables programmatic access to build artifacts. Suitable repository systems include Git, Nexus, NuGet, Subversion, Mercurial, and the like.

System configuration 110 can comprise information describing and identifying the build system (or systems) 112 used to build the original binary 102. Build system configuration 110 can comprise, for each machine used, a build system name (or other identifier), the name (or other authentication) of the logged in user, and data identifying the operating system and software installed on the machine at the time of the build.

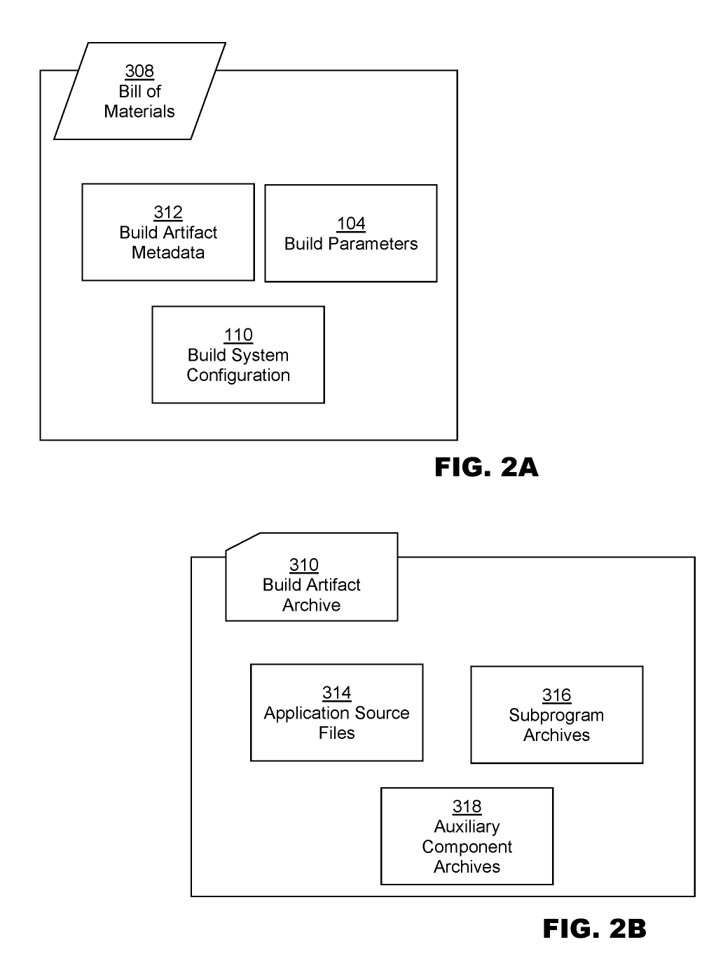

FIG. 2A is a schematic diagram depicting the structure of a bill of materials 308 according to an embodiment. Bill of materials 308 can comprise data entries describing the configuration and artifacts used to build original binary 102. In an embodiment, bill of materials 308 can comprise build artifact metadata 312, build parameters 104, and build system configuration 110.

Build artifact metadata 312 can comprise identifiers, versions, and repository information for each build artifact 106 used to create original binary 102. Build artifacts 106 can comprise source code files, source code directory structures, library files, build scripts, configuration files, and build machine images. In embodiments, build artifact metadata 312 can further include data entries that can be used to automatically substitute variables in a parameterized makefile or other build script.

Bill of materials 308 can comprise a key-value pair for each data element. Bill of materials 308 can comprise a format such as extensible Markup Language (XML), JavaScript Object Notation (JSON), or any other machine-readable data encoding scheme can be used.

FIG. 2B is a schematic diagram depicting the structure of a build artifact archive 310 according to an embodiment. Build artifact archive 310 can comprise application source files 314, subprogram archives 316, and auxiliary component archives 318.

Application source files 314 can comprise all of the source code files used to create original binary 102. In other embodiments, application source files 314 can include makefiles or other build scripts including substitutions made during the build process per build parameters 104 and build system configuration 110.

Subprogram archives 316 can comprise a build artifact archive, or other archive format containing subprograms such as library files and/or the build artifacts required to recreate each subprograms, as available. In embodiments, each subprogram archive 316 can comprise an augmented build artifact, including both the subprogram and prerequisite build artifacts. Embodiments can also support use cases that are less recursive. For example, subprogram archives 316 can comprise compiled or prebuilt subprograms. In these cases the build artifacts for each subprogram can be included with application source files 314.

Auxiliary component archives 318 can comprise install packages for tools or components that are required by original binary 102 when in use, or used to build original binary 102. For example, auxiliary component archives 318 can comprise installers for databases such as Informix or SQL Server, or build tools such as the .NET compiler platform, Maven, gcc, and the like. Auxiliary component archives 318 can further comprise build system software packages (such as operating system installers) and/or virtual machine images of the one or more build machines used to create original binary 102.

In general embodiments of build artifact archive 310 can comprise the complete set of source code files, software packages, and configuration settings necessary to rebuild original binary 102. Build artifact archive 310 can comprise a compressed archive format such as a ZIP file. Build artifact archive can be encoded in Base64, MIME, or any other encoding scheme known in the art.

In embodiments, build artifact archive 310 can be encrypted, such that application source files 314, subprogram archives 318, and auxiliary component archives 318 can only be accessed when an appropriate key is provided. In embodiments, all of build package 302 can be encrypted. In embodiments, separate encryption keys can be used for each component of build package 302, such that access to bill of materials 308 can be provided without also providing access to all of build artifact archive 310. Any suitable scheme for encryption of data at rest that is known in the art can be used. For example, build artifact archive 310 can be encrypted using ZIP encryption, file-based symmetric cryptography, file-based public-key cryptography, and the like. Embodiments can provide strong encryption using Advanced Encryption System (AES) or other algorithms with large key sizes. Other embodiments can be optimized for performance using smaller keys and less powerful algorithms—such as Data Encryption Standard (DES).

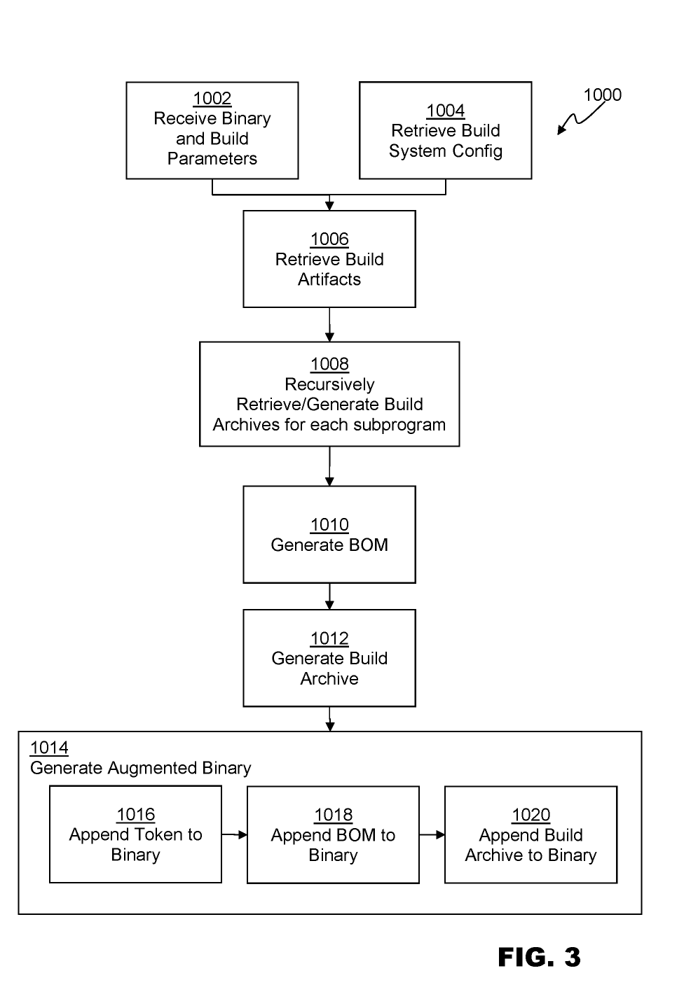

FIG. 3 is a flowchart depicting a method 1000 for creating augmented binary 300 according to an embodiment. At 1002, packager 100 can receive original binary 102 and build parameters 104. Build parameters can include information enabling packager 100 to retrieve build artifacts 106 from repository 108. In one embodiment, build parameters can comprise a uniform resource locator (URL) identifying the location of a Project Object Model (POM) file identifying the location of repository 108, the source files and other build artifacts 106 used to create original binary 102, and other configuration information.

At 1004, packager 100 can retrieve build system configuration 110 information regarding the system 112 used to build original binary 102. In one embodiment, packager 100 can query the operating system on which packager 100 is being executed to determine various items of build system configuration 110. In other embodiments, packager 100 can receive configuration information through a user interface or configuration file describing the build system 112, and any auxiliary components or software.

At 1006, packager can retrieve build artifacts 106. In embodiments, build artifacts 106 can be retrieved from one or more local or remote repositories 108. In embodiments, build artifacts 106 can be retrieved from local or networked file structures as directed, for example when packager 100 is executed at the end of a build process. This can prevent redundant downloading of artifacts from repository 108.

At 1008, packager 100 can evaluate each build artifact 106 to determine if it is a subprogram. Subprograms can be identified based on information in build parameters 104, a POM file, a makefile, or other build script, in embodiments. For each subprogram, packager 100 can recurse through method 1000 (or use other methods) to retrieve and/or generate build archives for the subprogram. In one embodiment, subprogram archives can be identified by links to NuGet, Nexus, or other repositories present in the POM file.

At 1010, the bill of materials 308, including build artifact metadata 312 can be generated based on the retrieved build artifacts 106, build parameters 104, and build system configuration 110.

At 1012 the build artifact archive 310 can be generated from build artifacts 106. As described above, at 1012 build archive can be encrypted. In embodiments, one or more encryption keys can be provided to packager 100 through a user interface, or can be automatically generated and provided as an output with augmented binary 300.

At 1014, augmented binary 300 can be created based on a copy of original binary 102. In embodiments, token 304 can be appended or inserted at 1016. At 1018, the generated bill of materials 308 can be appended or inserted. At 1020 the generated build archive 310 can be appended or inserted.

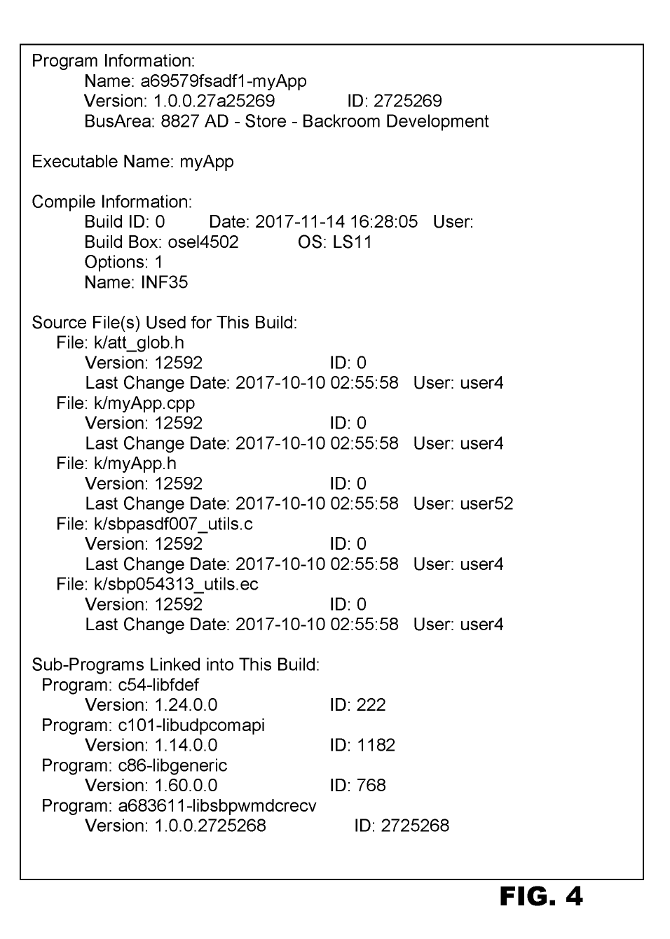

Extractor 200 can receive augmented binary 300 as input and produce an extracted bill of materials 202, extract build artifacts 204, or both. Extracted bill of materials 202 can be presented as an onscreen listing, or saved in a text or other file format (such as XML, comma separated values (CSV) and like). FIG. 4 is a text listing of output that can be produced by an embodiment of extractor 200.

Extracted build artifacts 204 can comprise application source files 314, subprogram archives 316, and auxiliary component archives 318. Extracted build artifacts 204 can be saved to a file storage location of the user's choosing. Embodiments of extractor 200 can receive selections of portions of build artifact archive 310 to be extracted, for example, when the user only requires certain files. Extractor 200 can receive one or more keys to enable full or partial decryption of an encrypted build artifact archive 310.

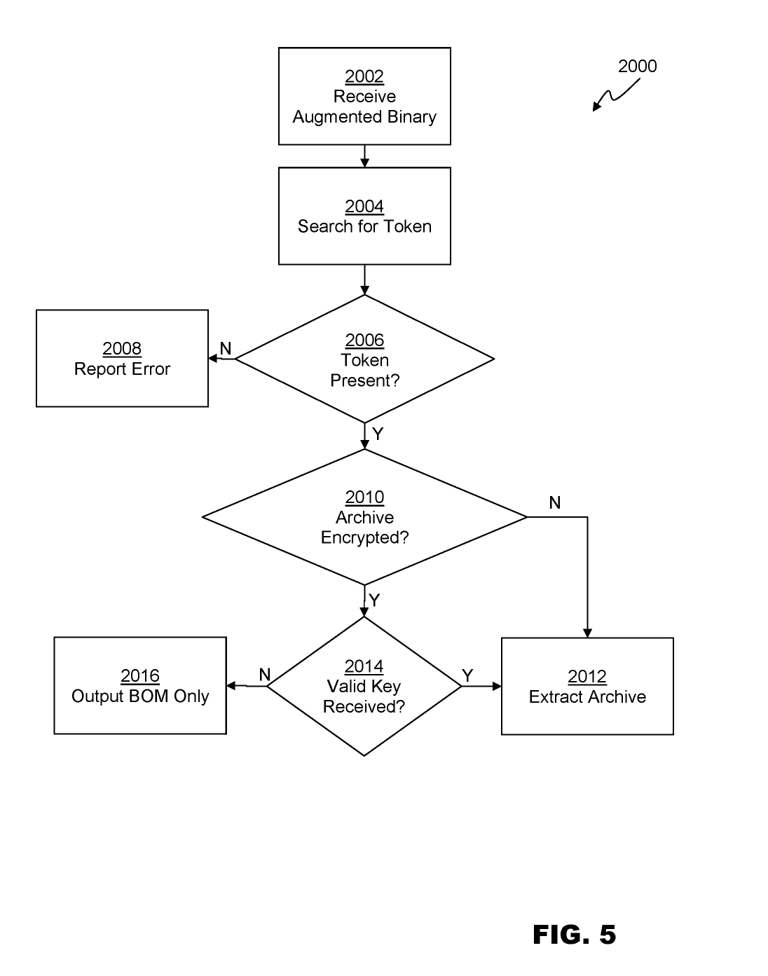

FIG. 5 is a flowchart depicting a method 2000 for extracting the bill of materials 308 and/or build artifact archive 310 from a provided augmented binary 300.

At 2002, a binary to be analyzed can be received. At 2004, token 304, or other indication of the presence of build package 302 can be searched for. If, at 2006, no token is present, an error can be reported at 2008. This check enables extractor 200 to be executed to analyze any binary without producing nonsensical results.

If a token is present, index 306 can be read to determine the structure of build package 302. Build artifact archive 310 can be examined to determine if all or part of it encrypted. If not, or if a valid key is received at 2014 build archive 310 can be extracted at 2012 to a location of the user's choice. If build artifact archive 310 is encrypted and no valid key is received, the all or part of the bill of materials 308 can be output at 2016.

Packager 100 and extractor 200 can comprise software applications or modules. In one embodiment, packager 100 and extractor 200 can be modules of a single software application. In another embodiment, packager 100 and extractor 200 can comprise separate software applications. In still another embodiment, the various functions of packager 100 and extractor 200 can be separated across multiple software utilities. For example extractor 200 can comprise a program information utility, configured to provide only the extracted bill of materials 202, and a program source utility, configured to provide the extracted build artifacts 204 to a directory of the user's choice.

In one embodiment, packager 100 and extractor 200 can be included in a utility with a command line interface, though graphical, web-based, mobile, or other application interfaces can be provided. In one embodiment, system 10 can comprise an application program interface (API) enabling programmatic access to the functionality of packager 100 and extractor 200. User inputs can optionally be received interactively, via prompts provided through a user interface. Embodiments of packager 100 can be launched as part an automated build process or workflow, such that the final output of the build process is augmented binary 300 instead of (or as well as) original binary 102.

Embodiments of package management system 10 can comprise a number of advantages. Extracted bill of materials 202 can provide version information which can be useful during investigation, troubleshooting, or auditing of a system containing a number of different binaries. Where the original repositories and build systems are still available, extracted bill of materials 202 can provide links or other references to repository locations of build artifacts.

Where the original repositories are no longer available, however, extracted build artifacts 204 can provide the original source and other artifacts needed to rebuild an augmented binary 300. This can facilitate porting or migration of legacy systems that include the binary between platforms (for example, from HP UNIX to Linux), or to add enhancements or fix bugs in legacy applications.

Embodiments of the present disclosure can also enable automated auditing processes. For example, audit or other compliance requirements may require that a certain version of a particular build artifact is, or is not, in use by the binaries present on a production system. Auditing tools can examine extracted bill of materials 202 for each binary on a system to determine compliance.

Embodiments of the present disclosure can enable intrusion detection system (IDS) tools to determine if a binary present on a system is authorized. For example, in one embodiment token 304, or another component of build package 302 can comprise a public key, hash, checksum, or other validation code that can be verified by the IDS tool. The IDS tool can flag or report any binaries present in a given location that do not have the appropriate validation data.

Embodiments of the present disclosure can facilitate the purchase or transfer of software assets. For example, a software application can be provided as one or more augmented binary files 300 including encrypted build artifact archives 310. The purchaser would be able to install, test, and use augmented binary files 300 to ensure that the software is acceptable. The purchaser can be provided with a decryption key to access the build artifact archive 310 after appropriate payment is received. In embodiments, the decryption key can be held in escrow. In embodiments, the original binary 102 may contain a version of the software including limited functionality. Upon receipt of a valid key, extractor 200 can extract a fully functional binary from build artifact archive 310.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one embodiment, the system 10 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A package management system for binary files including executable instructions, the system comprising:
a packager configured to:
identify a plurality of build artifacts used to create an original binary file, and
create and store an augmented binary file comprising the plurality of build artifacts appended to the original binary file, the augmented binary file having the same functionality when executed as the original binary file; and
an extractor configured to receive the augmented binary file and produce an output comprising the plurality of build artifacts from the augmented binary file.

2. The system of claim 1, wherein the packager is further configured to retrieve one or more prerequisite build artifacts, each prerequisite build artifact required to create at least one of the plurality of build artifacts, and to add the one or more prerequisite build artifacts to the plurality of build artifacts.

3. The system of claim 2, wherein the packager is configured to add the prerequisite build artifacts to the plurality of build artifacts by:
creating an augmented build artifact comprising a build artifact and the prerequisite build artifacts required to create the build artifact; and
adding the augmented build artifact to the plurality of build artifacts.

4. The system of claim 1, wherein the packager is further configured to append a bill of materials to the augmented binary file, the bill of materials comprising data identifying each build artifact of the plurality of build artifacts; and
further comprising a program information tool configured to receive the augmented binary file and produce an output comprising the bill of materials.

5. The system of claim 1, wherein the packager is configured to append the plurality of build artifacts to the original binary file by combining the plurality of build artifacts into an archive file and appending the archive file to the original binary file.

6. The system of claim 1 wherein each build artifact of the plurality of build artifacts has a type selected from the group consisting of: source code file, source code directory structure, library file, build parameter, build script, system components, build machine configuration, and build machine image.

7. The system of claim 1, wherein the packager is further configured to encrypt the plurality of build artifacts such that the extractor requires a decryption key to produce an output comprising the plurality of build artifacts from the augmented binary file.

8. The system of claim 1, wherein the packager is further configured to retrieve the plurality of build artifacts from one or more source code repositories.

9. The system of claim 1, wherein the extractor is further configured to build a new executable using the plurality of build artifacts of the received augmented binary file.

10. The system of claim 1, wherein the packager is further configured to append an identification signature to the augmented binary file.

11. The system of claim 9, wherein the identification signature is recognizable by a software auditing tool.

12. A method for building a binary file including executable instructions, the method comprising:
identifying a plurality of build artifacts used to create an original binary file;
creating and storing an augmented binary file comprising the plurality of build artifacts appended to the original binary file, the augmented binary file having the same functionality when executed as the original binary file;
extracting the plurality of build artifacts from the augmented binary file; and
creating a new binary file with the extracted plurality of build artifacts.

13. The method of claim 11, further comprising:
retrieving one or more prerequisite build artifacts, each prerequisite build artifact required to create at least one of the plurality of build artifacts; and
adding the one or more prerequisite build artifacts to the plurality of build artifacts.

14. The method of claim 13, wherein adding the one or more prerequisite build artifacts to the plurality of build artifacts comprises:
creating an augmented build artifact comprising a build artifact and the prerequisite build artifacts required to create the build artifact; and
adding the augmented build artifact to the plurality of build artifacts.

15. The method of claim 11, further comprising:
appending a bill of materials to the augmented binary file comprising data identifying each build artifact of the plurality of build artifacts; and
producing an output comprising the bill of materials from the received augmented binary file.

16. The method of claim 11, wherein the plurality of build artifacts are combined into an archive file, and the archive file is appended to the original binary file.

17. The method of claim 11, wherein each build artifact of the plurality of build artifacts has a type selected from the group consisting of: source code file, source code directory structure, library file, build parameter, build script, system components, build machine configuration, and build machine image.

18. The method of claim 11, further comprising encrypting the plurality of build artifacts such that a decryption key is required to extract the plurality of build artifacts from the augmented binary file.

19. The method of claim 11, further comprising retrieving the plurality of build artifacts from one or more source code repositories.

20. The method of claim 11, further comprising appending an identification signature to the augmented binary file.

21. The method of claim 18, wherein the identification signature is recognizable by a software auditing tool.
